(19) United States
(12) Patent Application Publication
(10) Pub. No.: US 2010/0325109 A1
(43) Pub. Date: Dec. 23, 2010

(54) KEYWORD CLASSIFICATION AND DETERMINATION IN LANGUAGE MODELLING

(75) Inventors: Shuanhu Bai, Singapore (CN); Haizhou Li, Terrace (SG)

Correspondence Address: MORRISON & FOERSTER LLP, 12531 HIGH BLUFF DRIVE, SUITE 100, SAN DIEGO, CA, 92130-2040, US

(73) Assignee: AGENCY FOR SCIENCE, TECHNOLOGY AND REARCH

(21) Appl. No.: 12/526,500

(22) PCT Filed: Feb. 9, 2007
(86) PCT No.: PCT/SG07/00044

§ 371 Date: Aug. 7, 2009

(51) Int. Cl. G06F 17/30

(52) U.S. Cl. 707/737; 707/749; 707/E17.044; 707/E17.089

(57) ABSTRACT

A computer-implemented method and apparatus defines a keyword class vector. A set of seed keywords is determined from a set of keywords and first and second most similar keywords from the set of seed keywords are then determined. A class vector is determined from first and second keyword vectors associated with the first and second most similar keywords. The method and apparatus also classifies a keyword in a keyword class. A similarity for a keyword vector associated with the keyword is determined with reference to a plurality of class vectors, each class vector having an associated class and determines a most similar class vector of the plurality of class vectors from the similarity determination. The keyword is then classified in a most similar class associated with the most similar class vector.

The invention relates to defining a keyword class and/or classifying a keyword in a keyword class and/or determining a keyword in a set of words. The invention has particular, but not exclusive, application in a task-oriented language modelling (TO-LM) system for voice and keyword mining.

Speech keyword mining is a technology used to detect one or more keywords from words in speech utterances. Unlike dictation systems, keyword mining systems only focus on the set of keywords a user is concerned with, the vocabulary of which is much smaller than that of a dictation system. Recognition performance of the keyword mining system for non-keywords is not such an important consideration.

Applications for keyword mining systems include homeland security and interactive dialogue systems. In homeland security applications, keyword mining systems are used to detect possible locations of sensitive words and can help a user to reduce significantly the efforts required of scanning an entire recorded speech utterance manually.

In interactive dialogue systems, keyword mining technologies can be used to guide the dialogue when certain keywords are detected, and enhance the flexibility and robustness of the system. A typical example is a call handling system dedicated to financial services. When the utterances “credit card” and “bill” are recorded and recognised by the call transfer system, it is likely, or at least possible, the user wishes to discuss a credit card bill. The call handling system then routes the call to a billing department. This kind of service is called natural language call routing. The paper by Bernhard Suhm “Lessons learned from Deploying Natural Language Call Routing at Verizon” whitepaper, BBN Technologies discloses an example of such a system.

For different keyword mining applications in different domains (i.e. areas of interest), different sets of keywords will be required. When the keyword set is changed, the performance of a system will likely also change depending on the extent of the changes made to the keyword set. For instance, a keyword mining system for financial services, as discussed above, will not likely provide good performance if used for, say, a technical support help line application.

In a speech recognition system, a language model (LM) is coupled to an acoustic model in a recogniser for enhancing the recognition performance. A LM provides the selection of vocabularies and word level guide for word associations. For any given language, the acoustic model is relatively static while the language model is dynamic because it is closer to the process of dealing with task-specific interfaces defined in natural language. Usually speech recognition commercial system vendors, who target interactive dialogue systems, provide well-built acoustic models for a language and language model development tools such as finite-state grammar formalisms and a compiler. When building an application system, acoustic models are incorporated directly from the commercial system while LMs are developed by highly-skilled experts who are experienced in grammar writing and familiar with the task specific data sets.

Generally speaking, there are two steps in LM development: training data collection and training with the collected data. Traditionally, training data is collected from balanced domain sources to deal with different language situations. The training document corpus is a collection of text files. In the n-gram formalism, a training process is conducted over the texts by, first of all, counting word frequencies in the training corpus and selecting the top K most frequent words as the LM vocabulary. The N-gram data is then generated for the vocabulary set from the corpus. LMs developed with this approach are expected to perform well for all words in the vocabulary set and are frequently used for dictation systems. But in domain-specific keyword mining systems, this LM development approach does not generate a model that is sharp enough to perform well on the keywords because the data for training is generic for all the words.

There are efforts for data collection from the internet as disclosed by Viet Bac L E, Brigitte Bigi, et al in “Using the Web for fast language model construction in minority languages”, Euro-speech 2003 and for LM generation for keyword spotting by Babak Hodjat, Horacio Franco, et al in “Iterative Statistical Language Model Generation for use with an Agent-Oriented Natural Language Interface”, 10th International Conference on Human-Computer Interaction, 2003.

U.S. Pat. No. 6,430,551 discloses a system for creating a vocabulary and/or statistical language model from a textual training corpus. This document discloses a system which identifies at least one context identifier and derives at least one search criterion, such as a keyword, from the context identifier. The system then selects documents from a set of documents based upon the search criterion.

For domain-specific applications, it is necessary to apply a task partitioning and/or word clustering process to a vocabulary set or a document corpus, because domain-specific users wish to focus on groups of words pertaining to the domain, and ignore other words/documents not in that domain. In task partitioning, a keyword set is partitioned into subsets according to criteria which allow keywords sharing a mutual context the most in the training corpus to be grouped together and keywords sharing the mutual context the least are separated. A single model does not provide acceptable performance returns for disparate domains.

Task partitioning is often regarded as a means for building domain-specific models according to keyword distributions in the training corpus. Known algorithms for this purpose include the Independent Component Analysis (ICA) and the Probabilistic Latent Semantic Indexing (PLSI) algorithms, the latter being described in “Probabilistic Latent Semantic Indexing”, Proceedings of the Twenty-Second Annual International SIGIR Conference on Research and Development in Information Retrieval by Thomas Hoffman.

However, if the number of training documents and words in the keyword set is large, the ICA and PLSI algorithms are unsuitable for the task of task partitioning in these circumstances. This is because implementation of these algorithms imposes a very heavy burden on memory of the processor on which the algorithms are run. Both the ICA and PLSI algorithms involve a very significant number of matrix computations. The sizes of the matrices are determined by the vocabulary size in and the number of documents n, in the form of m times n. Furthermore, during computation of the algorithms, the relevant matrices are loaded into the processor memory because the matrix elements are accessed and used randomly according to the algorithm. Thus, very high specification processors with very large memories are required in order to implement these algorithms.

The invention is defined in the independent claims. Some optional features of the invention are defined in the dependent claims.

A first step in the task partitioning process comprises defining one or more keyword classes. This is done by defining a keyword class vector from a set of seed keywords. An example of a keyword class vector is a matrix having elements representing the class. A second step comprises classifying a keyword in a keyword class. This is done by determining a similarity for a keyword vector associated with the keyword with reference to a plurality of class vectors. An example of a keyword vector is a matrix having elements representing the keyword.

Implementation of a task partitioning process as claimed allows partitioning of the keyword set into subsets so that keywords sharing a mutual context the most in the training corpus are grouped together, and those sharing the mutual context less are grouped in separate keywords sets.

Therefore, the inventors have developed a scalable algorithm which can handle any size of keyword set and training corpus and achieve partitioning of keywords into subsets with a better performance than known algorithms. One significant technical advantage offered by the present task partitioning algorithms is that a processor with lesser memory requirements may be utilised in implementation of the algorithms. Conversely, it can be considered that a given processor can implement the algorithms described herein more efficiently for larger data sets than known algorithms. This is because most data used and processed by the algorithms described herein (in the form of data matrices) can be stored on, say, a hard drive during a clustering process. The task partitioning algorithms described herein process word vectors one-by-one in a predefined order in order to determine the class/class vector. Therefore, data can be stored on, for example, a hard drive and extracted for processing as required. There is no requirement, as there is in the prior art, to load the data sets in their entirety into “fast” memory such as processor RAM.

Thus, the task partitioning algorithms described herein are practical for all data sets whereas prior art algorithms, such as the ICA and PLSI algorithms require significant resources in terms both of processing power and processing memory. This renders these algorithms somewhat impracticable for huge data sets comprising, say, elements or matrices comprising rows/columns with thousands or tens of thousands of entries.

In processing words one-by-one in a predefined order, the algorithm described herein perform complex computations on seed words (defined below), merging the non-seed words to the classes one-by-one deterministically by comparing word vectors to class vectors. This implementation reduces significantly the resources required by the algorithm. One reason for this is, as mentioned above, that the non-seed words are stored in, say, a hard drive and the time required to perform the algorithm is in linear relation to the number of words in the matrices. The memory requirement for the algorithms described herein corresponds approximately with the number of seed words multiplied by the number of documents n. This may be significantly less than that required by known algorithms.

A method of classifying a keyword in a keyword class is also defined. One method classifies the keyword in a keyword class identified from the task partitioning process mentioned above. In a first step of this method, a similarity score for a keyword vector associated with a keyword is determined with reference to a plurality of class vectors, each class vector being associated with a class. A most similar class vector of the plurality of class vectors is determined from a similarity determination and the keyword is classified in a most similar class associated with the most similar class vector.

Another method allows for determination of a keyword in a set of words. This method comprises assigning a distance parameter for a first word in a word set which designates a first word distance from the word set. A document is parsed for an occurrence of the first word in the document. Upon identification of an occurrence of the first word in the document, the distance parameter is modified. Upon determination the modified distance parameter satisfies a threshold criterion, the word is designated as a keyword.

The present invention will now be described, by way of example only, and with reference to the accompanying drawings in which:

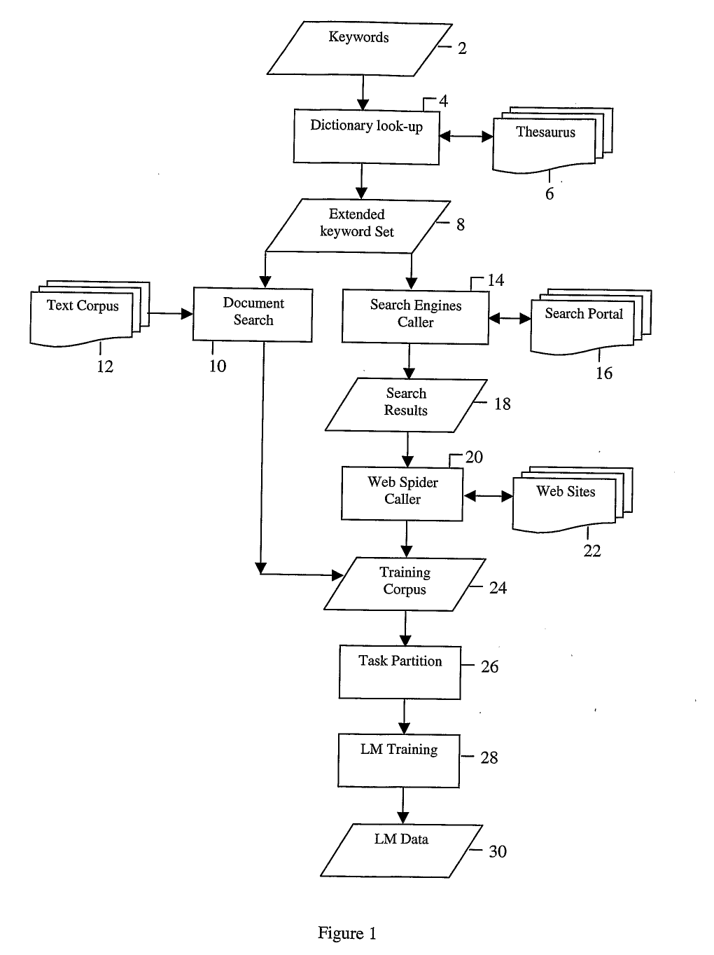

FIG. 1 is a logic flow diagram illustrating an example of a TO-LM training process;

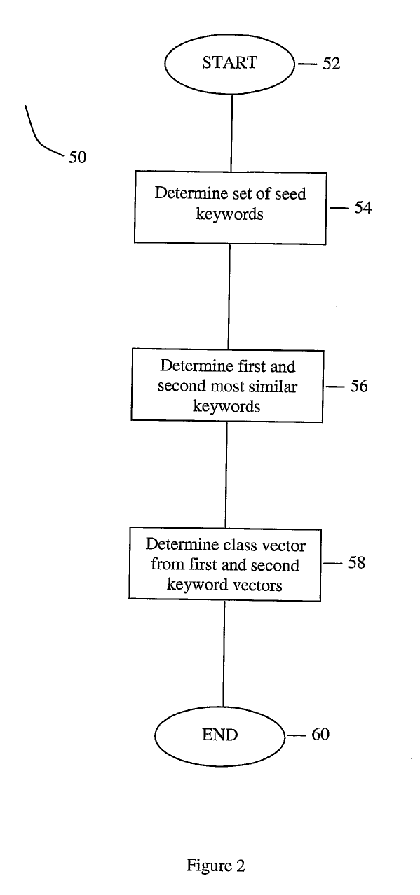

FIG. 2 is a logic flow diagram illustrating a first method for defining a class vector;

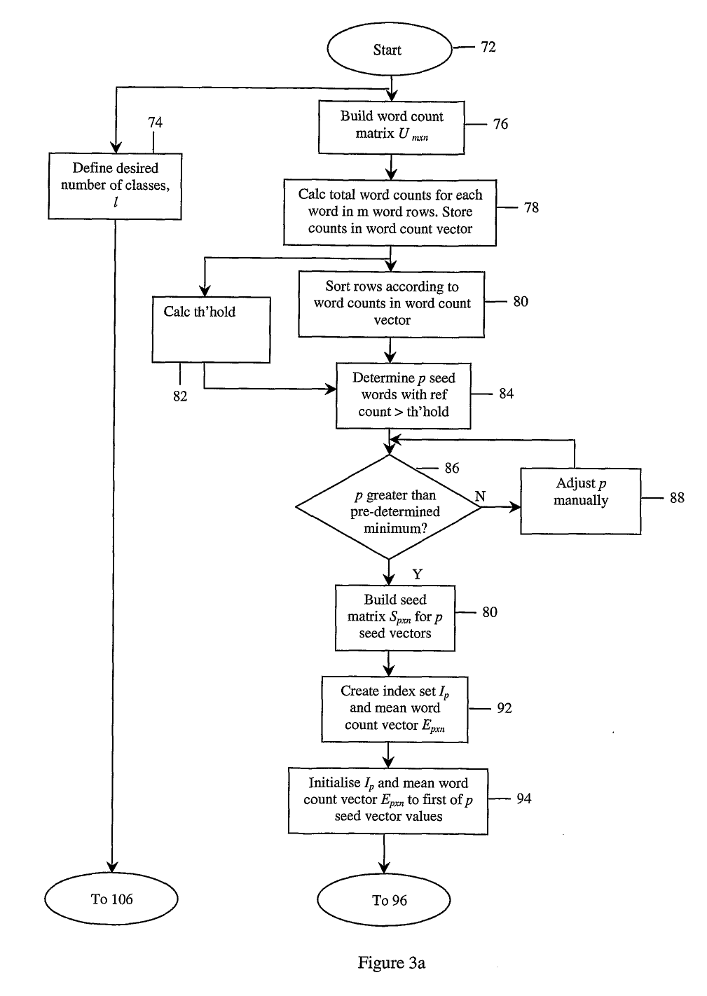

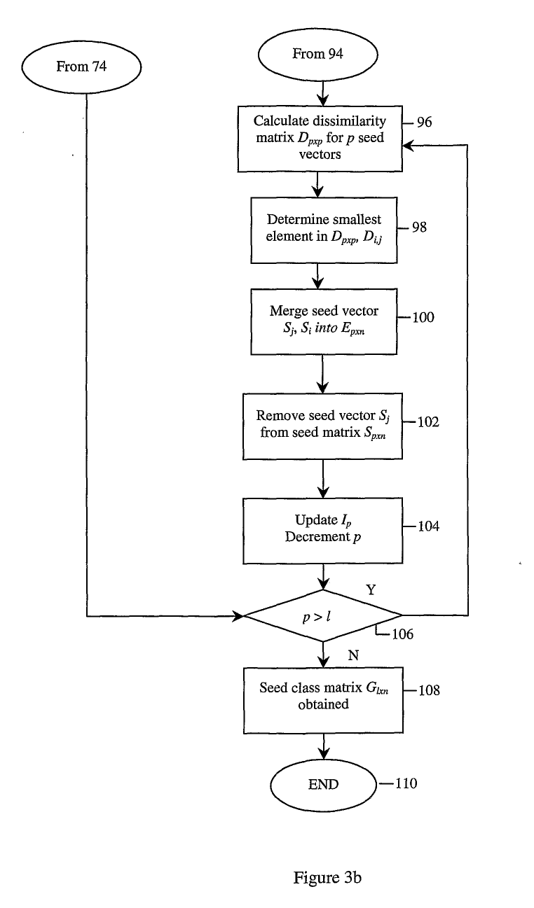

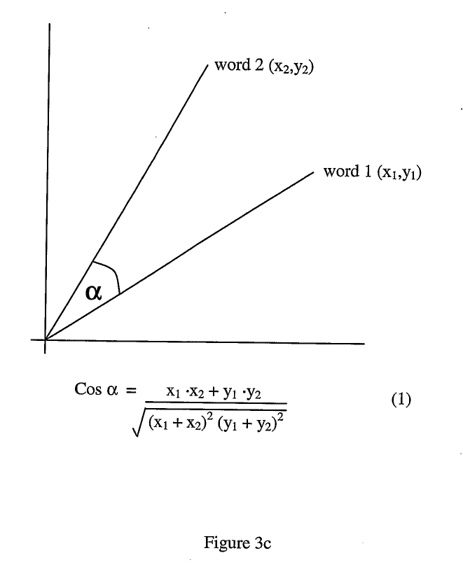

FIG. 3 is a logic flow diagram illustrating a second method for defining a class vector, which can be used in defining a plurality of keyword classes;

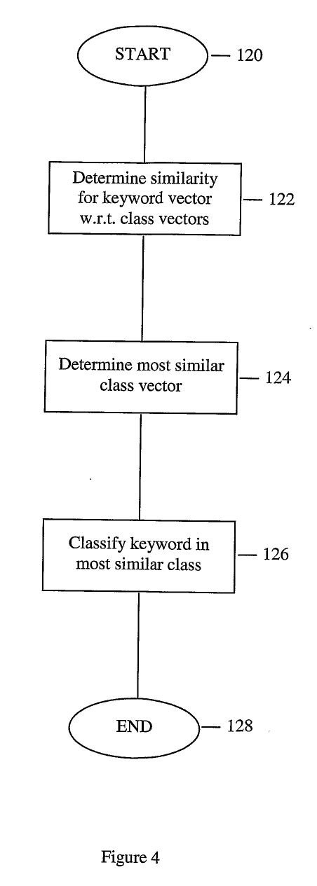

FIG. 4 is a logic flow diagram illustrating a first method for classifying a keyword in a class;

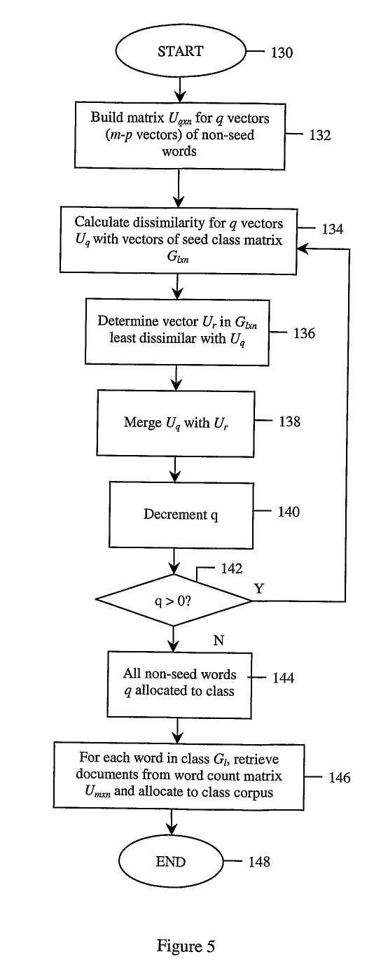

FIG. 5 is a logic flow diagram illustrating a second method for classifying a keyword in a class, which can be used in classifying a plurality of keywords in a plurality of classes;

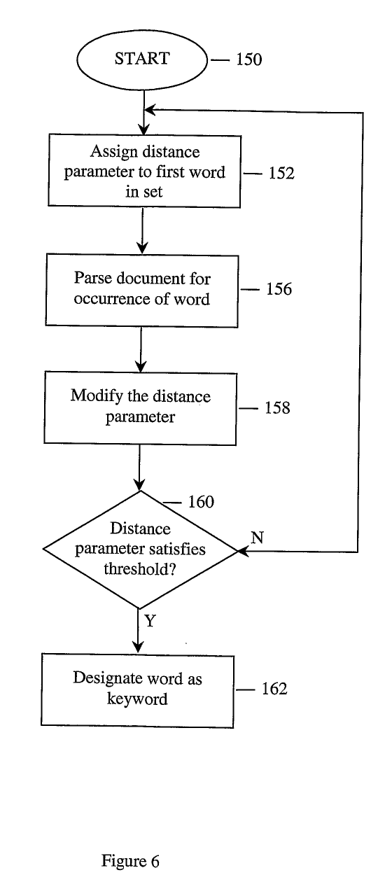

FIG. 6 is a logic flow diagram illustrating a method for determining a keyword in a set of words;

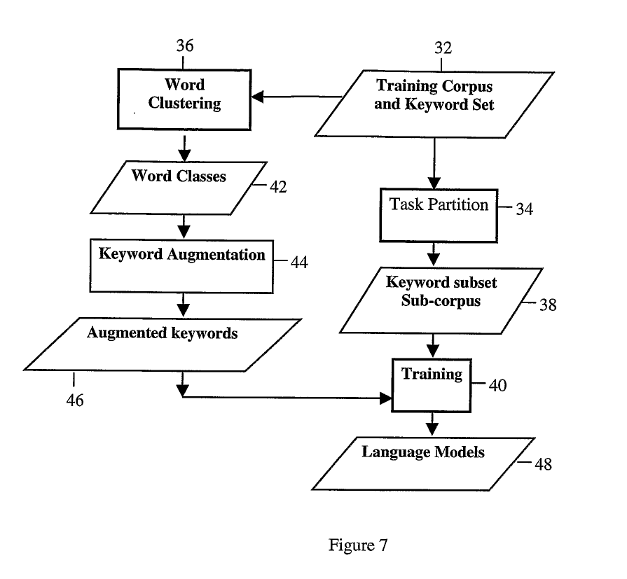

FIG. 7 is a logic flow diagram illustrating an example of a process for building a language model;

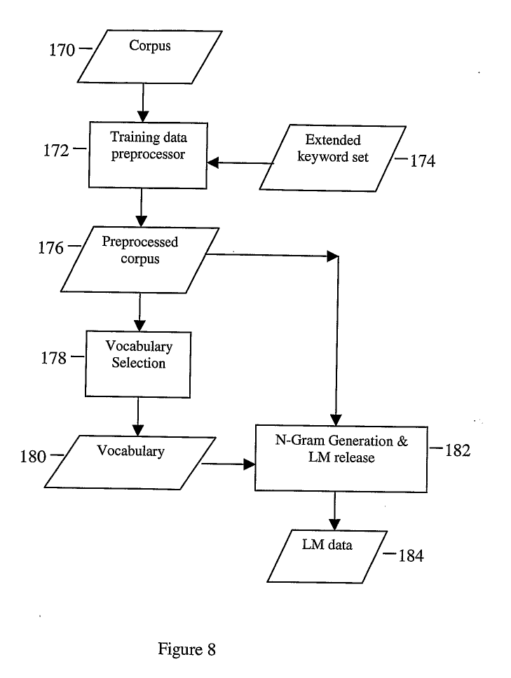

FIG. 8 is a logic flow diagram illustrating a training process for a TO-LM approach;

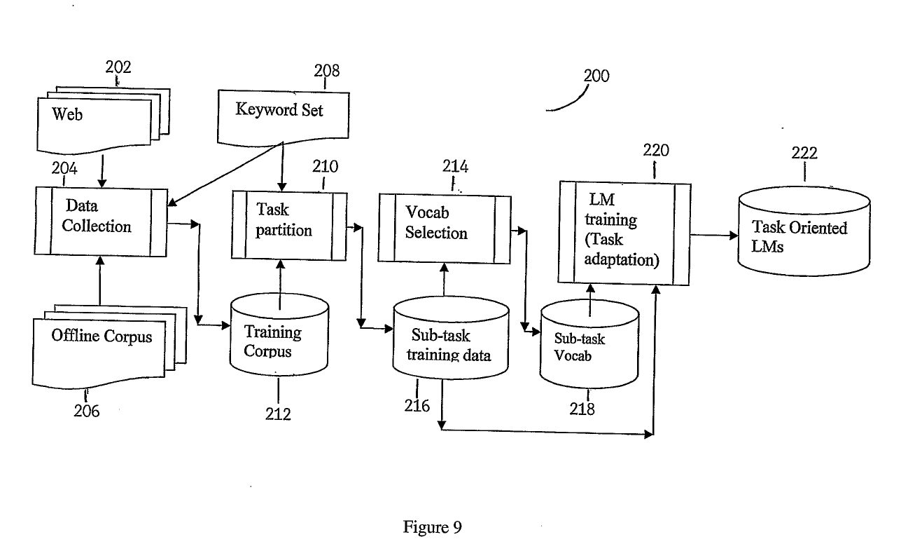

FIG. 9 is a block diagram illustrating a system architecture for carrying out the processes of FIGS. 1 to 8.

Referring now to FIG. 1, an example of a TO-LM training process is described. Initially, a keyword set 2 is derived from a task-specific application or specified by an end user. The keyword set 2 is extended iteratively by parsing and extracting data from on-line dictionary resources 4 or on-line thesaurus resources 6. An extended keyword set is consolidated in step 8 and is used either by a document search process 10 to pick out relevant text from available off-line sources such as text corpus 12 or by a search engine caller 14 to perform internet search tasks with a search portal 16 to generate search results 18, defining a collection of URLs. This set of search results 18, after some simple pre-processing such as removal of duplicated entries, is used by a web spider application 20 to retrieve text from websites 22 found at the URLs in the set of search results 18. The information (documents) retrieved from these websites defines a training document corpus 24. This corpus 24 may be supplemented by documents found in the document search process 10. The training corpus data is then subjected to a task partition process 26 (described below) and language model training 28 (also described below) to provide language model data 30.

In a vector space model, words, documents and word/document classes may be represented as vectors. Groups of words, documents and classes may be represented by matrices comprising a plurality of vectors. The elements of the vectors are counts of words appearing in reference documents. The elements of each row of the matrices can be defined as a count of a word in the reference documents, and the elements in each column can be defined as a number of times reference documents are referenced by words. Therefore, m rows in a matrix Uₘₓₙ are vectors representing word distributions in documents and n columns in matrix Uₘₓₙ are vectors representing document distributions over words. If the words and training documents are significantly large (e.g. each of them being in the tens of thousands) any processing algorithm must be able to handle the complexity of the data and memory requirements for such complex data manipulations. The algorithms described with reference to FIGS. 2 to 5 are designed to handle data of any size and to achieve acceptable performance within a reasonable time. In the examples described with reference to FIGS. 2 to 5, a significant improvement in accuracy can be achieved for the language model when compared to language models built with known systems. With these examples, a language model with improved accuracy can be built within 2 to 3 hours, with an “ordinary” known desktop computer with a specification of, say, 3 GHz microprocessor and 1 GB of random access memory.

Significant concepts for the algorithms are as follows:
The algorithms are sensitive to the training corpus size and avoid sparse data problems (where large numbers of elements in the matrices are zero entries). The training corpus size is a factor in determining the number of partitions in the task partitioning process described below. A user can decide on the number of classes/partitions by, for example, applying an empirical formula. One example of a suitable formula is T/(N×N×K)>=10 where T is the bigram count summation of the corpus, N is the expected vocabulary size for each model (say, 20,000) and K is the number of classes/partitions. From this, an average bigram count is 10. The algorithms can achieve good performance results within reasonable time for very large data.
The algorithms are fully automatic to perform the process in an optimal fashion.

Referring to FIG. 2, a first method for defining a class and/or a class vector is now described. The individual steps of the algorithm will be described in greater detail with reference to FIG. 3.

Prior to initialisation of the algorithm, the extended set of keywords 8 and training corpus 24 are stored on disc. The task partitioning algorithm is implemented by a processor of a, for example, personal computer. When matrices are built, these, too, are also stored on disc, and the contents of the matrices are accessed and manipulated by the processors/algorithm as required.

The process 50 of FIG. 2 begins at step 52. At step 54, the algorithm analyses the extended set of keywords 8 from FIG. 1 to determine a set of seed keywords, where the seed keywords are those keywords in the keyword set most relevant to the domain specific to the application in question. At step 56, the algorithm determines first and second most similar keywords from the set of seed keywords. The first and second most similar keywords are those keywords in the set of seed keywords which are most similar to one another. At step 58, the algorithm determines a class vector from the first and second keyword vectors which are associated with the first and second most similar keywords. Effectively, by definition of a class vector containing elements representing the class, a class of keywords is defined by the process of FIG. 2.

A second, more detailed example of an algorithm for defining one or more class vectors is now described in relation to FIG. 3. The algorithm consists of two main steps: firstly, this algorithm also determines potential seed words from the extended keyword set 8 and performs optimisation amongst the seed words. The number of seed words is determined by the vocabulary set and seed matrix size is defined by the number of seed words and the number of documents in the training corpus. The second step of the algorithm is to merge the non-seed keywords with the seed keywords according to distance measurement criteria.

The algorithm 70 begins at step 72. At step 74, a user defines the number l of classes and/or class vectors for the classification of the partitioning process. The number l of classes is used later in the algorithm as described below with respect to step 106. At step 76, a word count matrix Uₘₓₙ is built. The word count matrix is a matrix comprising a series of m row vectors having elements denoting the word count of each of m words in n reference documents. At step 78, the total word count for each word in m word rows is calculated from

$${\sum }_{j = 1}^{n} {U}_{i , j} ,$$

where U_{i,j} is the matrix element representing the count for the i^{th} of m words in the j^{th} of n documents. That is, the word count is determined from a count of an element in a keyword vector associated with the keyword, the element representing a number of occurrences of the keyword in a reference document. If there is a minimum of one non-zero element in the m^{th} word vector, the word count will return a non-zero result. After having been summed, the word counts for the individual m word row vectors are stored in a word count vector.

At step 80, the m word rows in the word count matrix Uₘₓₙ are sorted according to the word count in the word count vector built at step 78.

In parallel to step 80, a threshold criterion is calculated at step 82. One method of calculating the threshold criterion is to calculate an average of the word counts for each word in the word count matrix by summing the total word counts for the keywords and averaging these for the number of words and/or reference documents.

At step 84, any seed keywords which have a reference word count greater than the threshold is determined. Therefore, at steps 80, 82 and 84, the algorithm determines a set of seed keywords from a word count of each of the set of keywords in a set of reference documents and adds a keyword to the set of seed keywords from the word count for that keyword satisfies a threshold criterion. In the example given, the threshold criterion is that the word count is greater than an average word count.

At step 86, the algorithm determines whether the number p of seed keywords is greater than a pre-determined minimum. If this is not the case, the algorithm allows the user to adjust the number p of seed keywords manually. One method of doing this is to allow the user to remove those seed keywords with the lowest words counts in the group of seed keywords. By doing so, the user is allowed to refine the set of keywords manually; in this example, the user refines the set of seed keywords by removing selected keywords from the set of seed keywords. Alternatively, the algorithm can be configured to perform this step automatically.

This step obviates a situation where, if the average word count is too low, the seed matrix, described below, may not be accurate. Generally speaking, the greater the average word count, the better performance the task partitioning algorithm can provide, as is well known in the art.

The algorithm loops around steps 86 and 88 until a number of seed keywords p is sufficient for the user's purposes. At step 90, a seed matrix Sₚₓₙ for p seed vectors is built. At step 92, an index set Iₚ and mean keyword count vector Eₚₓₙ are created. At step 94, Iₚ and the mean word count vector Eₚₓₙ are initialised to the first of the p seed vector values. At step 96, a similarity (or dissimilarity) matrix for the p seed vectors is determined. For each of the set of seed keywords, a measure of similarity, (or dissimilarity) for a seed keyword vector is made with keyword vectors as associated with the other keywords of the set of seed keywords. In the present example it is convenient to calculate a dissimilarity matrix according to a dissimilarity measure of the angular separation of two vectors in the seed matrix Sₚₓₙ calculated from:

$${D}_{i , j} = ( {\sum }_{k = 1}^{n} {E}_{x 1 , y 1} {E}_{x 2 , y 2} ) / {( {\sum }_{k = 1}^{n} {E}_{x 1 , y 1}^{2} {\sum }_{k = 1}^{n} {E}_{x 2 , y 2}^{2} )}^{1 / 2}$$

where E_{x1,y1} is the seed matrix Sₚₓₙ element for x1^{th} word in the y1^{th} document and E_{x2,y2} is the seed matrix Sₚₓₙ element for x2^{th} word in the y 2^{th} document. That is, the similarity (or dissimilarity) scores may be determined from an angular separation in vector space of elements of the seed vectors. An illustration of this is shown in FIG. 3c where vectors in vector space for two words w1, w2 are shown. The angle between two vectors is defined by Equation 1 of FIG. 3c.

The dissimilarity matrix Dₚₓₚ can be considered as a triangle matrix having elements representing the “distance” or dissimilarity between words of the p seed words. At step 98, the first and second keyword vectors which are most similar to one another are determined. At step 100, the seed vectors for the two most similar keyword vectors are merged into the mean keyword count vector Eₚₓₙ. This is done by identifying the smallest element in the triangle matrix. For example, for D_{i,j}, merge class j to i and update Eₚₓₙ and Iₚ by

$${E}_{i} = ( {\sum }_{k ∈ {I}_{i} , {I}_{j}} {S}_{k} ) / ( {I}_{i}^{\#} + {I}_{j}^{\#} ) ,$$

where I^{#} is the number of elements in set I. Then, all the elements in Iⱼ to Iᵢ are added. Another example of this merging is for the average value of corresponding elements in the two most similar keyword vectors to be averaged and written into a corresponding element of the mean keyword count vector Eₚₓₙ.

Subsequent to this, the seed vector for one of the most similar keywords is removed from the seed matrix Sₚₓₙ, the index set Iₚ is updated at step 104 and the number p of seed keywords is decremented. At step 106, the number p is compared with the number of classes l defined by the user at step 74. If the number of seed keywords p is greater than l, the algorithm loops back to step 96 and the process is repeated until it is determined at step 106 that the number of seed vectors p is not greater than the number of classes l. A seed class matrix Gₗₓₙ of seed class vectors is built at step 108. The seed class matrix vectors define the keyword classes for the set of keywords. The process ends at step 110.

Referring now to FIG. 4, a first algorithm for classifying a keyword in a keyword class is now described. The process begins at step 120 and, at step 122, a similarity (or dissimilarity) for a keyword vector with respect to class vectors (say, the class vectors obtained in the algorithm of FIG. 3) is made. At step 124, a most similar class vector is determined from the similarity determination. That is, the class vector of the plurality of class vectors which is most similar to the keyword vector is determined. Subsequently, at step 126, the keyword is classified in the most similar class associated with the most similar class vector. The process ends at step 128.

A second, more detailed algorithm for allocating a keyword or a plurality of keywords to one or more keyword classes is described with reference to FIG. 5. The algorithm begins at step 130 and, at step 132, a matrix U_{qxn} for q vectors of non-seed words is built. If the total number of words in the keyword set is m and p seed words are defined in the algorithm of FIG. 3, the non-seed keywords number a total of q=m−p. Matrix U_{qxn} can therefore be considered to be built from the non-seed word vectors. At step 134, a similarity (or dissimilarity) measure for each of q vectors U_{q} from the matrix U_{qxn} with class vectors (say, class vectors of the seed class matrix Gₗₓₙ obtained by the algorithm of FIG. 3) is made. The algorithm calculates similarity (or dissimilarity) scores for the keyword vector with reference to the plurality of class vectors in the seed class matrix Gₗₓₙ. In one implementation, the similarity scores are determined from a measure of an angular separation in vector space of elements of the keyword vector and the class vectors similar to the determination of the similarity matrix in the algorithm of FIG. 3c. At step 136, class vector Uᵣ of seed class matrix Gₗₓₙ which is least dissimilar with the vector U_{q}, the dissimilarity calculation being determined in a manner as described above. At step 138, vector U_{q} is merged with vector Uᵣ (the manner of merging being similar to that with respect to FIG. 3) described above. That is, the keyword is classified by merging the keyword vector with the most similar class vector. At step 140, number q is decremented as vector U_{q} has been merged into vector Uᵣ. At step 142, a determination as to whether the number of non-seed word vectors is greater than zero is made. If q is greater than zero, the algorithm loops back to step 134 and the process is repeated until all non-seed words q are allocated to a class at step 144.

The non-seed key word vector comprises an element identifying a number of occurrences of that keyword in a reference document. At step 146, the algorithm assigns the reference document to a most similar class document corpus when the number of occurrences for that document is non-zero.

Therefore, the algorithm of FIG. 5 allocates the non-seed keywords to the class vectors.

FIG. 6 illustrates a method for determining a keyword from a set of words. The process begins at step 150 and, at step 152, a distance parameter for a first word in the keyword set to the set itself is assigned. One way of doing this is to assign a value to the distance parameter. A reference document in the training corpus for the class for the key word is then parsed for an occurrence of the word at step 156. If an occurrence of the word is found in the document, the distance parameter is modified at step 158. In one implementation of the algorithm, the algorithm extracts a text string from the document in which the word occurs and the distance parameter is modified in dependence of a position of the word in the text string. For instance, the value of the distance parameter could be set to say, 100, and each time an occurrence of the word is found in the document, the distance parameter is modified at step 158 by decrementing the distance parameter.

This process may be repeated for multiple documents in the document corpus and, upon detection of each occurrence of the word in a document, the distance parameter is modified. At step 160, a determination as to whether or not the distance parameter satisfies a threshold is made. One example of the threshold to be satisfied is that the word is that word in the word set which has the smallest distance to the keyword set. If the distance parameter does not the satisfy a threshold criterion, the process loops back to step 156. When the distance parameter satisfies a threshold criterion at step 160, the word is designated a keyword at step 162. In one implementation, the threshold criterion to be satisfied is that keywords with the smallest distances to the keyword set are identified; that is, the distance parameter for that keyword is the smallest after being decremented a number of times after having been found in the document(s). At step 162 the word is designated as a keyword.

FIG. 7 illustrates the building of the language model in more detail. Initially, and starting from the training corpus and keyword set described above, the task partition process 34 partitions the training corpus and keywords into smaller groups 38. In parallel, the training corpus and keyword set 32 are subjected to word clustering 36. Word clustering is applied if the training corpus is not big enough for a particular keyword subset, and words having the same or similar grammatical class are imported into the keyword subset. A vocabulary list is extracted from the corpus to group words into classes 42 in a grammatical manner (e.g. as described in U.S. Pat. No. 6,430,551). After this, augmented keyword subsets 46 are obtained as a result of a keyword augmentation process 44 in which words are added to the keyword set which share the same grammatical class as words in the keyword set. The result of the task partitioning 34 and keyword augmentation 46 blocks are used for language model training 40 to generate optimised models for the sub-tasks and the language models 48.

Referring now to FIG. 8, the document corpus 170 obtained with reference to FIG. 5 and the extended keyword set 174 are used in the training process. The training corpus 170 is first passed through a training data pre-processor 172 which performs tokenisation and entity recognition tasks to provide a pre-processed corpus 176. Examples of known systems which can perform the tokenisation and entry recognition tasks are Babak Hodjat, Horacio Franco, et al “Iterative Statistical Language Model Generation for use with an Agent-Oriented Natural Language Interface”, 10th International Conference on Human-Computer Interaction, 2003 and Shihong Yu, Shuanhu Bai, Paul Wu, “Description of Kent Ridge Digital Labs System Used for MUC-7”, MUC7 Proceeding, 1998. The vocabulary selection process 178 is then invoked to build the vocabulary set for the system. This vocabulary selection process is described above with reference to FIG. 6. The vocabulary keyword set 180 is then identified and passed to process step 182 for N-gram generation and LM release. The language model data 184 is then compiled.

A system architecture 200 for performing the algorithms of FIGS. 1 to 8 is illustrated in FIG. 9. The Data Collection process 204 takes the keyword set 208 as input along with text data information from the internet 202. Data collection process 204 also extracts relevant keyword texts from Offline Corpus 206 if available. The output of Data Collection process 204 is supplied to Training Corpus 212, in which each document contains at least one keyword. Keyword Set 208 can also be augmented using a thesaurus as illustrated in FIG. 1. After data collection, the Task Partition process 210 is applied, which takes Keyword Set 208 and Training Corpus 212 as inputs, splitting Keyword Set 208 into smaller subsets (i.e. partitions) and Training Corpus 212 into smaller groups with less overlap. Task Partition process 210 outputs Sub-task Training Data 216 which comprises partitioned subsets of Keyword Set 208 and related subsets of Training Corpus 212.

Vocabulary Selection process 214 is used on the Sub-task Training data 216, to extract vocabularies for language models of each subtask. This module collects words appearing in the texts adjacent to or near positions of keywords in documents and produces a vocabulary set for each sub-task called Sub-task Vocabulary 218.

Finally, LM Training process 220 is applied. This process works on Sub-task Training Data 216 and Sub-task Vocabulary 218 to build sub-task language models, or Task Oriented language models 222. This process can also be used in language model task adaptation. The adaptation process simply updates the existing models by the data extracted from extra training corpus which is not used before.

Thus, the method uses a task-specific LM adaptation approach aiming at improving voice mining performance. It exploits information that is readily available in the internet, thus adapting the LM in an automatic manner. Performance of LMs built in this approach may significantly reduce keyword perplexity by 30-50%. The perplexity reduction will be translated to an overall improvement in voice mining performance.

It will be appreciated that the invention has been described by way of example only and that various modifications may be made in detail without departure from the spirit and scope of the claims. Features presented in one aspect of the invention may be presented in combination with other aspects of the invention as appropriate.

1. A computer-implemented method for defining a keyword class vector, comprising:
determining a set of seed keywords from a set of keywords;
determining first and second most similar keywords from the set of seed keywords; and
determining a class vector from first and second keyword vectors associated with the first and second most similar keywords.

2. The method of claim 1, wherein determining the class vector comprises merging the first and second keyword vectors.

3. The method of claim 1, wherein the method comprises determining first and second most similar keywords by determining, for each of the set of seed keywords, a measure of similarity for a keyword vector associated with a seed keyword with keyword vectors associated with the other keywords of the set of seed keywords, and determining first and second keyword vectors which are most similar to one another.

4. The method of claim 1, wherein the method comprises determining the set of seed keywords from a word count of each of the set of keywords in a set of reference documents and adding a keyword to the set of seed keywords when the word count for that keyword satisfies a threshold criterion.

5. The method of claim 4, wherein the method comprises determining the word count from a count of an element in a keyword vector associated with the keyword, the element representing a number of occurrences of the keyword in a reference document.

6. The method of claim 4, further comprising allowing a user to refine the set of seed keywords.

7. The method of claim 6, wherein allowing a user to refine the set of seed keywords comprises allowing the user to remove selected keywords from the set of seed keywords.

8. The method of claim 4, wherein the method comprises calculating a threshold value as an average of keyword word counts, the threshold criterion being that the word count for that keyword is greater than the threshold value.

9. The method of claim 1, further comprising allowing a user to define a number of classes and/or class vectors for the classification.

10. The method of claim 1, the method being further for classifying a keyword in a keyword class and comprising:
determining a similarity for a keyword vector associated with the keyword with reference to a plurality of class vectors, each class vector having an associated class;
determining a most similar class vector of the plurality of class vectors from the similarity determination; and
classifying the keyword in a most similar class associated with the most similar class vector.

11. A computer-implemented method for classifying a keyword in a keyword class, the method comprising:
determining a similarity for a keyword vector associated with the keyword with reference to a plurality of class vectors, each class vector having an associated class;
determining a most similar class vector of the plurality of class vectors from the similarity determination; and
classifying the keyword in a most similar class associated with the most similar class vector.

12. The method of claim 11, wherein the method comprises performing the similarity determination by calculating similarity scores for the keyword vector with reference to the plurality of class vectors.

13. The method of claim 11, wherein the keyword vector comprises an element identifying a number of occurrences of the keyword in a reference document, the method further comprising assigning the reference document to a most similar class document corpus when the number of occurrences is non-zero.

14. The method of claim 11, wherein the method comprises classifying the keyword in the most similar class from a merger of the keyword vector with the most similar class vector.

15. The method of claim 11, wherein the method comprises determining the similarity scores from a measure of an angular separation in vector space of elements of the keyword vector and the class vectors.

16. A computer-implemented method for determining a keyword in a set of words, the method comprising:
assigning a distance parameter for a first word in the word set, the distance parameter designating a first word distance from the word set;
parsing a document for an occurrence of the first word in the document;
upon identification of an occurrence of the first word in the document, modifying the distance parameter; and
upon determination the modified distance parameter satisfies a threshold criterion, designating the word as a keyword.

17. The method of claim 16, further comprising, upon identification of an occurrence of the first word in the document, modifying the distance parameter in dependence of a position of the first word in the document.

18. The method of claim 16, further comprising, upon identification of an occurrence of the first word in the document, extracting a text string from the document in which the first word occurs and modifying the distance parameter in dependence of a position of the first word in the document comprises modifying the distance in dependence of a position of the word in the text string.

19. The method of claim 16, the method being executed for a plurality of words and comprising determining a plurality of modified distance parameters for the plurality of words and designating a subset of the plurality of words satisfying the threshold criterion as keywords.

20. The method of claim 19, wherein the threshold criterion to be determined comprises a determination of a plurality of keywords with modified distance parameters designating the least distance from the word set.

21. Apparatus for defining a keyword class vector, the apparatus being configured to:
determine a set of seed keywords from a set of keywords;
determine first and second most similar keywords from the set of seed keywords; and
determine a class vector from first and second keyword vectors associated with the first and second most similar keywords.

22. Apparatus for classifying a keyword in a keyword class, the apparatus being configured to:
determine a similarity for a keyword vector associated with the keyword with reference to a plurality of class vectors, each class vector having an associated class;
determine a most similar class vector of the plurality of class vectors from the similarity determination; and
classifying the keyword in a most similar class associated with the most similar class vector.

23. Apparatus for determining a keyword in a set of words, the apparatus being configured to:
assign a distance parameter for a first word in the word set, the distance parameter designating a first word distance from the word set;
parse a document for an occurrence of the first word in the document;
upon identification of an occurrence of the first word in the document, modify the distance parameter; and
upon determination the modified distance parameter satisfies a threshold criterion, designate the word as a keyword.

24. (canceled)

25. A computer program product having computer code stored thereon for defining a keyword class, the computer code being configured to:
determine a set of seed keywords from a set of keywords;
determine first and second most similar keywords from the set of seed keywords; and
determine a class vector from first and second keyword vectors associated with the first and second most similar keywords.

26. A computer program product having computer code stored thereon for classifying a keyword in a keyword class, the computer code being configured to:
determine a similarity for a keyword vector associated with the keyword with reference to a plurality of class vectors, each class vector having an associated class;
determine a most similar class vector of the plurality of class vectors from the similarity determination; and classifying the keyword in a most similar class associated with the most similar class vector.

27. A computer program product having computer code stored thereon for classifying a keyword in a keyword class, the computer code being configured to:
assign a distance parameter for a first word in the word set, the distance parameter designating a first word distance from the word set;
parse a document for an occurrence of the first word in the document;
upon identification of an occurrence of the first word in the document, modify the distance parameter; and
upon determination the modified distance parameter satisfies a threshold criterion, designate the word as a keyword.

28. (canceled)
